(19) United States
(12) Patent Application Publication
(10) Pub. No.: US 2025/0373610 A1
(43) Pub. Date: Dec. 4, 2025

(54) TECHNIQUES FOR AUTHORIZING ACTIVITIES ACROSS COMPUTING DEVICES

(71) Applicant: Apple Inc., Cupertino, CA (US)

(72) Inventors: Andrew T. WHITEHEAD, Frisco, TX (US); Austin A. MARUSCO, Georgetown, TX (US); Christopher G. SKOGEN, Los Altos Hills, CA (US); Peter W. ROMAN, Los Altos, CA (US); Roberto GARCIA, Los Gatos, CA (US)

(21) Appl. No.: 19/227,332

(22) Filed: Jun. 3, 2025

Related U.S. Application Data
(60) Provisional application No. 63/656,046, filed on Jun. 4, 2024.

(51) Int. Cl. H04L 9/40

(52) U.S. Cl. CPC H04L 63/0884

(57) ABSTRACT

A method for authorizing activities across computing devices is disclosed. The method may include receiving, from a software application executing on a requestor computing device, a request to perform a particular action, identifying a grantor computing device capable of authorizing the particular action to be performed, and generating, based at least on the particular action, a request package that includes a question and at least one answer choice. The method may further include transmitting, to the grantor computing device, the request package to cause the grantor computing device to output a user interface that enables a selection of the at least one answer choice, receiving, from the grantor computing device, a selected answer choice from the at least one answer choice, and handling the particular action in accordance with the selected answer choice.

### CROSS-REFERENCE TO RELATED APPLICATIONS

The present application claims the benefit of U.S. Provisional Application No. 63/656,046, entitled “TECHNIQUES FOR AUTHORIZING ACTIVITIES ACROSS COMPUTING DEVICES,” filed Jun. 4, 2024, the content of which is incorporated by reference herein in its entirety for all purposes.

### FIELD

The described embodiments relate generally to authorizing activities across computing devices. More particularly, the described embodiments set forth techniques for enabling requestor computing devices to issue requests to grantor computing devices for authorization to perform particular actions.

### BACKGROUND

In the digital age, managing children's screen time and regulating their access to online content has become a significant challenge for parents and guardians. While computing devices offer valuable educational resources and entertainment options, excessive exposure can lead to many issues, including addiction, impaired social skills, and developmental delays. Balancing the benefits and risks of screen time requires a nuanced approach that considers various factors, including age, developmental stage, and individual needs.

One of the primary difficulties in managing children's screen time is the pervasive nature of technology in modern society. Screens are everywhere, from smartphones and tablets to laptops and smart TVs, making it increasingly challenging to effectively monitor and control a child's digital consumption. With the rise of remote learning and digital entertainment, children are spending more time than ever in front of screens, which blurs the lines between educational and recreational activities.

Another challenge is the allure of engaging content available online. The Internet offers a vast array of videos, games, and social media platforms designed to captivate young minds. However, much of this content may not be suitable for children, containing explicit language, violence, or inappropriate themes. Determined children often can find ways to bypass restrictions that are imposed, which provides an ongoing challenge for parents trying to safeguard their children's online experiences.

### SUMMARY

The described aspects relate generally to authorizing activities across computing devices. More particularly, the described aspects set forth techniques for enabling requestor computing devices to issue requests to grantor computing devices for authorization to perform particular actions.

According to some aspects, the method can be implemented by a requestor computing device, and includes the steps of receiving, from a software application executing on the requestor computing device, a request to perform a particular action, identifying at least one grantor computing device capable of authorizing the particular action to be performed, generating, based at least on the particular action, a request package that includes a question and at least one answer choice, transmitting, to the at least one grantor computing device, the request package to cause the at least one grantor computing device to output a user interface that enables a selection of the at least one answer choice, receiving, from the at least one grantor computing device, a selected answer choice from the at least one answer choice, and handling the particular action in accordance with the selected answer choice.

According to some aspects, the method can be implemented by a grantor computing device, and includes the steps of receiving, from a requestor computing device, a request package that is based on a software application executing on the requestor computing device issuing a request to perform a particular action, wherein the request package includes a question and at least one answer choice, outputting a user interface that enables a selection of the at least one answer choice, receiving a selected answer choice from the at least one answer choice, and providing the selected answer choice to the requestor computing device to cause the requestor computing device to handle the particular action in accordance with the selected at least one answer choice.

Other aspects include a non-transitory computer readable storage medium configured to store instructions that, when executed by a processor included in a computing device, cause the computing device to carry out the various steps of any of the foregoing methods. Further aspects include a computing device that is configured to carry out the various steps of any of the foregoing methods.

Other aspects and advantages of the disclosure described herein will become apparent from the following detailed description taken in conjunction with the accompanying drawings which illustrate, by way of example, the principles of the disclosure described herein.

### BRIEF DESCRIPTION OF THE DRAWINGS

The included drawings are for illustrative purposes and serve only to provide examples of possible structures and arrangements for the disclosed apparatuses and methods for providing wireless computing devices. These drawings in no way limit any changes in form and detail that may be made to the embodiments by one skilled in the art consistent with the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIGS. 2A-2B illustrate sequence diagrams of a first technique for authorizing activities across computing devices, according to some embodiments.

FIGS. 3A-3B illustrate sequence diagrams of a second technique for authorizing activities across computing devices, according to some embodiments.

FIGS. 4A-4B illustrate conceptual diagrams of user interfaces for authorizing activities across computing devices, according to some embodiments.

FIG. 5 illustrates a method implemented by a requestor computing device for authorizing activities across computing devices, according to some embodiments.

FIG. 6 illustrates a method implemented by a grantor computing device for authorizing activities across computing devices, according to some embodiments.

FIG. 7 is a block diagram of an embodiment of a system for authorizing communication between user devices.

FIG. 8 is a block diagram depicting an embodiment of a system for authorizing communication within an application being executed on multiple user devices.

FIG. 9 is a flow diagram depicting an embodiment of a method for authorizing communication between user devices.

FIG. 10 is a flow diagram depicting an embodiment of a method for authorizing communication within an application being executed on multiple user devices.

FIG. 11 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made consistent with the spirit and scope of the described embodiments.

The described embodiments relate generally to authorizing activities across computing devices. More particularly, the described embodiments set forth techniques for enabling requestor computing devices to issue requests to grantor computing devices for authorization to perform particular actions.

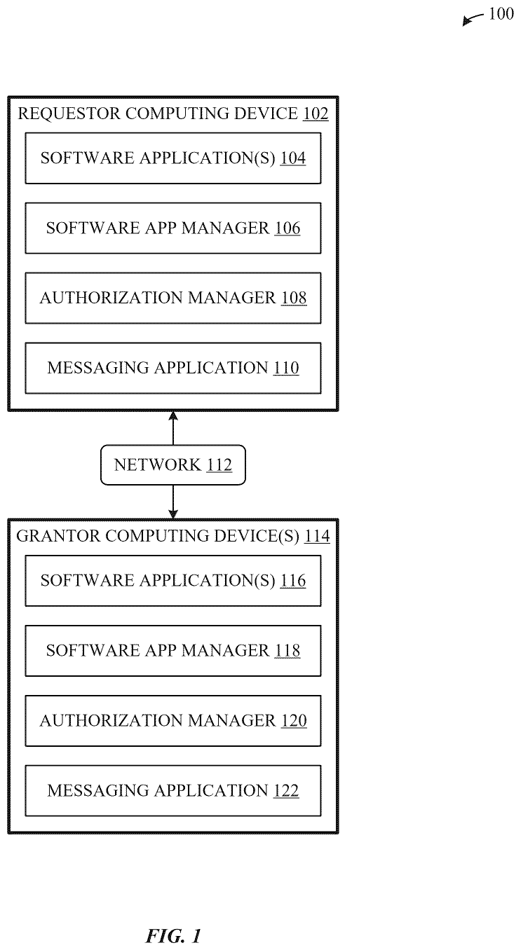

FIG. 1 illustrates a block diagram of a system 100, which includes different computing devices that can be configured to implement the various techniques described herein, according to some embodiments. More specifically, FIG. 1 illustrates a high-level overview of a requestor computing device 102 and one or more grantor computing devices 114, which can communicate with one another via a network 112 (e.g., a local network connection, the Internet, etc.). According to some embodiments, a given requestor computing device 102/grantor computing device 114 can represent any form of computing device operated by an individual, an entity, etc., such as a wearable computing device, a smartphone computing device, a tablet computing device, a laptop computing device, a desktop computing device, a gaming computing device, a smart home computing device, an Internet of Things (IoT) computing device, a rack mount computing device, and so on. It is noted that the foregoing examples are not meant to be limiting, and that each computing device can represent any type, form, etc., of computing device, consistent with the scope of this disclosure.

According to some embodiments, and as described herein, the requestor computing device 102 can represent a computing device that requires permission from a grantor computing device 114 in order to perform certain actions. For example, the requestor computing device 102 can be associated with a first type of user account that is assigned limitations, restrictions, etc., that require authorization from a second type of user account in order to be modified, lifted etc. In this regard, one or more grantor computing devices 114 (inherently associated with the requestor computing device 102) can be associated with the second type of user account. Accordingly, the requestor computing device 102 can generally represent any computing device that is operated by an individual—e.g., a child—where it is prudent to exercise some level of control over the operation of the requestor computing device 102, and the grantor computing device 114 can generally represent any computing device that is operated by an individual—e.g., a parent, a guardian, etc., of the aforementioned child. According to some embodiments, the aforementioned user accounts can belong to a family group, where the second type of user account has broad discretion to add, remove, modify, etc., first and second types of user accounts relative to the family group. It is noted that the foregoing examples are not meant to be limiting, and that any number, type, form, etc., of user account(s) can be implemented to effectively limit the requestor computing device 102 in some way and enable the grantor computing devices 114 to adjust the limitations, consistent with the scope of this disclosure.

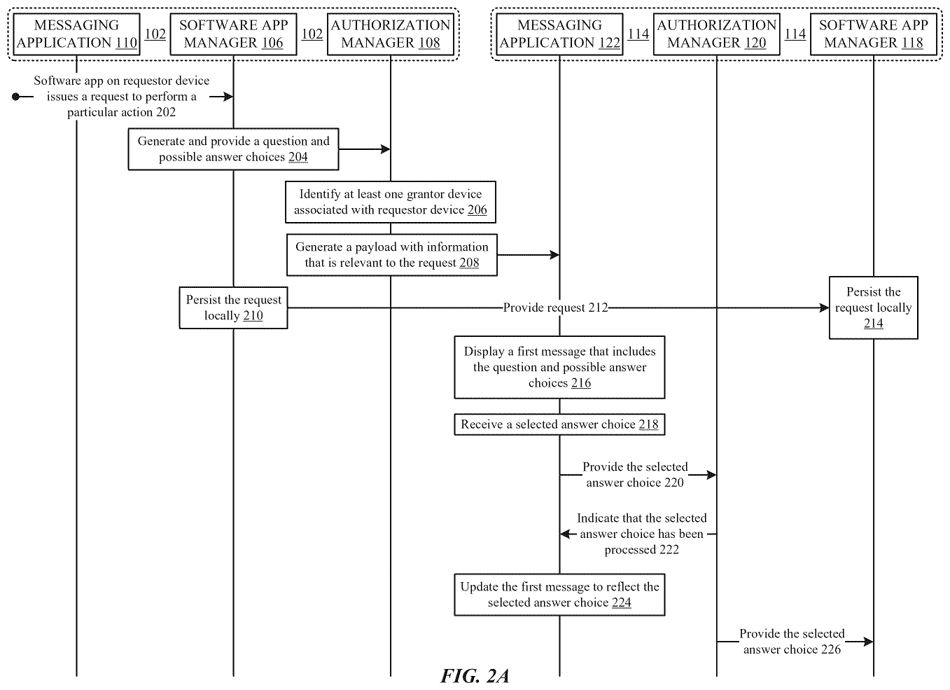

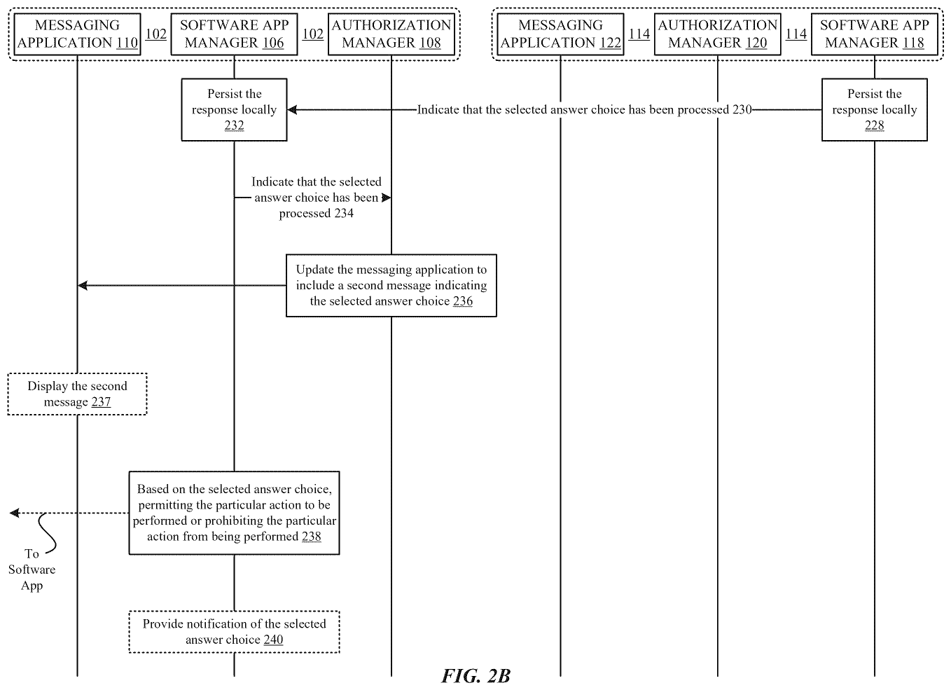

As shown in FIG. 1, the requestor computing device 102 can be configured to execute one or more software applications 104. A given software application 104 can represent, for example, a software application that is native to the OS of the requestor computing device 102, a third-party software application (e.g., downloaded from a digital software application store, the Internet, etc.), and so on. According to some embodiments, the software application manager 106 can represent a software application configured to control functional aspects of the software applications 104 on the requestor computing device 102. For example, the software application manager 106 can manage temporal aspects associated a given software application 104 (e.g., times at which the software application 104 can execute, lengths of time that the software application 104 can execute, etc.), feature aspects associated with the software application 104 (e.g., different functions that can/cannot be utilized within/by the software application 104), services associated with the software application 104 (e.g., purchases that can/cannot be made through the software application 104, network connections that can/cannot be access through the software application 104, etc.), and so on. It is noted that the foregoing examples are not meant to be limiting, and that the software application manager 106 can control any number, type, form, etc., of feature(s) implemented, accessed by, etc., the software applications 104, at any level of granularity, consistent with the scope of this disclosure. A more detailed explanation of how the software application manager 106 functions is provided below in conjunction with FIGS. 2A-2B, 3A-3B, 4A-4B, and 5A-5B.

As also shown in FIG. 1, the requestor computing device 102 can be configured to implement an authorization manager 108. According to some embodiments, the authorization manager 108 can be configured to facilitate authorization processes when a given software application 104 issues, to the software application manager 106, a request to perform a particular action that, at least at the time of the request, requires an approval from a corresponding grantor computing device 114. In particular, when the authorization manager 108 receives the request, the authorization manager 108 can be configured to identify at least one grantor computing device 114 capable of authorizing the request, and then interface with the grantor computing device 114 to obtain an authorization for the request. A more detailed explanation of how the authorization manager 108 functions is provided below in conjunction with FIGS. 2A-2B, 3A-3B, 4A-4B, and 5A-5B.

As also shown in FIG. 1, the requestor computing device 102 can be configured to implement a messaging application 110. The messaging application 110 represent, for example, a software application that enables users/software entities to exchange messages with other messaging applications 110 executing on other computing devices. According to some embodiments—and, as described in greater detail herein—the messaging application 110 can be configured to, in conjunction with issuing a given request package (generated in conjunction with the requestor computing device 102 issuing a request (to at least one grantor computing device 114) to perform a particular action), display a message that indicates whether the request was received by the grantor computing device 114, how/whether the grantor computing device 114 responded to the request, and so on. A more detailed explanation of how the messaging application 110 functions is provided below in conjunction with FIGS. 2A-2B, 3A-3B, 4A-4B, and 5A-5B.

Additionally, and as shown in FIG. 1, each grantor computing device 114 can be configured to execute software applications 116 (that is akin to the software applications 104), a software application manager 118 (that is akin to the software application manager 106), an authorization manager 120 (that is akin to the authorization manager 108), and a messaging application 122 (that is akin to the messaging application 122). As described herein, the software application manager 118, the authorization manager 120, and the messaging application 122 can provide similar, complementary, etc., functionalities to those provided by the software application manager 106, the authorization manager 108, and the messaging application 110 implemented on the requestor computing device 102.

For example, the software application manager 118 can enable a user (e.g., a parent, guardian, etc.) to adjust the manner(s) in which an associated requestor computing device 102 is permitted to operate. The software application manager 118 can also enable the user to view requests that have been received from requestor computing devices 102 to perform particular actions. In another example, the authorization manager 120 can be configured to manage, facilitate, etc., requests to perform particular actions, authorizations received to perform the particular actions, and so on. In another example, the messaging application 110 can be configured to, in conjunction with receiving a given request package (generated in conjunction with the requestor computing device 102 issuing a request to perform a particular action), display a message that includes information included in, derived from, etc., the request package. More detailed explanations of how the software application manager 118, authorization manager 120, and messaging application 122 function are provided below in conjunction with FIGS. 2A-2B, 3A-3B, 4A-4B, and 5A-5B.

It is noted that the logical breakdown of the entities illustrated in FIG. 1—as well as the logical flow of the manner in which such entities communicate—should not be construed as limiting. To the contrary, any of the entities illustrated in FIG. 1 can be separated into additional entities within the system 100, combined together within the system 100, or removed from the system 100, consistent with the scope of this disclosure. It should additionally be understood that the computing devices can include other entities that enable the implementation of the various techniques described herein, consistent with the scope of this disclosure. It should further be understood that the various entities described herein can be implemented using software-based or hardware-based approaches, consistent with the scope of this disclosure.

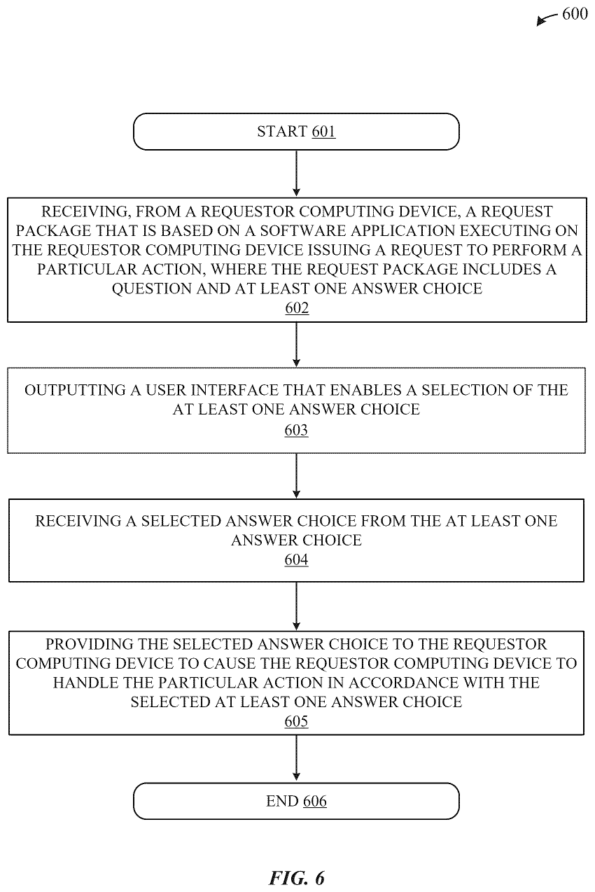

It should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another. A more detailed explanation of these hardware components is provided below in conjunction with FIG. 6.

Accordingly, FIG. 1 provides an overview of the manner in which different computing devices can be configured to implement the various techniques described herein, according to some embodiments. A more detailed breakdown of the manner in which these techniques can be implemented will now be provided below in conjunction with FIGS. 2A-2B, 3A-3B, 4A-4B, and 5A-5B.

FIGS. 2A-2B illustrate sequence diagrams of a first technique for authorizing activities across computing devices, according to some embodiments. As shown in FIG. 2A, the sequence diagram begins at step 202, where a software application 104 on a requestor computing device 102 issues, to the software application manager 106, a request to perform a particular action. The request can represent, for example, a request to continue utilizing the software application 104 beyond a usage time that has expired, a request to perform a particular function associated with the software application 104 (or another software application, entity, etc., with which the software application 104 is interfacing), and so on. It is noted that the foregoing examples are not meant to be limiting, and that the request can represent a request to perform any number, type, form, etc., of action(s), at any level of granularity, consistent with the scope of this disclosure. As described herein, the software application 104 operates under the control of the software application manager 106. In this regard, the request can be issued to/received by the software application manager 106.

At step 204, the software application manager 106 generates and provides, to the authorization manager 108, a question and possible answer choices. The question and possible answer choices can be based on, for example, the requestor computing device 102 (e.g., a unique identifier associated with the requestor computing device 102, a name associated with the requestor computing device 102, etc.), the user account associated with the requestor computing device 102 (e.g., a unique identifier associated with the user account, a name associated with the user account, etc.), the software application 104 (e.g., a unique identifier associated with the software application 104, a name associated with the software application 104, etc.), information included in the request (e.g., a description of the request, timestamp information associated with the request, suggested question/possible answer choices provided by the software application 104, etc.), and so on. In one example, the request indicates that a user (e.g., “Michael Smith”) of the requestor computing device 102 is executing a software application 104 (e.g., “Media Application”), and that the user desires to utilize the software application 104 for an additional fifteen minutes outside of what is presently allowed for the software application 104. In this example, the question can take the form of “Michael is asking to use Media Application for fifteen more minutes”, and the possible answer choices can include {Deny, Permit, Permit for 5 minutes, Permit for 10 minutes}. It is noted that the foregoing examples are not meant to be limiting, and that the software application manager 106 can generate the question/any number of answer choices based on any amount, type, form, etc., of information, at any level of granularity, consistent with the scope of this disclosure.

At step 206, the authorization manager 108 identifies one or more grantor computing devices 114 associated with the requestor computing device 102. As described herein, the authorization manager 108 can look up information about a family group to which the requestor computing device 102 and at least one grantor computing device 114 belong, to thereby identify the at least one grantor computing device 114. The authorization manager 108 can make this determination locally, and/or can interface with one or more server computing devices (e.g., that implement a cloud-based service) that manage the family group (and user accounts belonging thereto), depending on the configuration under which the requestor computing device 102 and the grantor computing device(s) 114 are operating.

At step 208, the authorization manager 108 generates a payload with information that is relevant to the request. The information can include, for example, all or some of the information included in the request, the question and possible answer choices, information associated with the requestor computing device 102, and so on. It is noted that the foregoing examples are not meant to be limiting, and that the payload can include any amount, type, form, etc., of information, at any level of granularity, consistent with the scope of this disclosure. According to some embodiments, the payload can be formatted in a manner that is understood by the grantor computing device 114/entities implemented thereon, so that the payload can be interpreted upon receipt to effectively extract the information from the request.

As shown in FIG. 2A, the authorization manager 108 provides the payload to the grantor computing device 114. According to some embodiments, the authorization manager 108 utilizes a messaging protocol that is accessible to the authorization manager 108, e.g., by way of the messaging application 110. The messaging protocol is also accessible to the messaging application 122/authorization manager 120 executing on the grantor computing device 114. In this manner, the authorization manager 108 can generate a message that is directed to the grantor computing device 114 (e.g., by way of a unique identifier associated with the grantor computing device 114, a unique identifier associated with a user account on the grantor computing device 114, etc.), incorporate the payload into a body of the message, and then transmit the message to grantor computing device 114. In turn, the messaging application 122 on the grantor computing device 114 can receive the message and then process the payload (e.g., in accordance with the techniques described below in conjunction with step 216).

At step 210, the software application manager 106 persists the request locally on the requestor computing device 102. This step can involve, for example, storing the information that is relevant to the request (discussed above in conjunction with step 208), other relevant information, and so on, so that it can be retrieved by the software application manager 106 when necessary. It should be appreciated that unique identifiers can be utilized where appropriate to enable the request to effectively be looked up, interacted with, etc., on the requestor computing device 102. For example, the software application manager 106 can store a unique identifier associated with the request so that multiple requests (whether pending or completed) can be effectively managed by the software application manager 106.

At step 212, the software application manager 106 provides the request to a software application manager 118 executing on the grantor computing device 114. Any communications protocol can be utilized to enable the software application manager 106 and the software application manager 118 to communicate information between one another, consistent with the scope of this disclosure. In turn, at step 214, the software application manager 118 persists the request locally on the grantor computing device 114 (e.g., using the same or a similar approach used to persist the request locally on the requestor computing device 102 at step 210, described above).

At step 216, the messaging application 122 displays a first message that includes the question and possible answer choices (as well as any other information that is relevant, useful, etc.). At step 218, the messaging application 122 receives a selected answer choice from among the possible answer choices, and, at step 220, the messaging application 122 provides the selected answer choice to the authorization manager 120. In turn, at step 222, the authorization manager 120 indicates, to the messaging application 122, that the selected answer choice has been processed (i.e., registered within/by the authorization manager 120). At step 224, the messaging application 122 updates the first message to reflect the selected answer choice, that the selected answer choice has been processed, etc. At step 226, the authorization manager 120 provides the selected answer choice to the software application manager 118.

Turning now to FIG. 2B, at step 228, the software application manager 118 persists the response (i.e., the selected answer choice) locally (e.g., using the persistence techniques described herein). At step 230, the software application manager 118, indicates, to the software application manager 106 executing on the requestor computing device 102, that the selected answer choice has been processed. Again, any communications protocol can be utilized to enable the software application manager 118 and the software application manager 106 to communicate information between one another, consistent with the scope of this disclosure. At step 232, software application manager 106 persists the response locally (e.g., using the persistence techniques described herein).

At step 234, the software application manager 106 indicates, to the authorization manager 108, that the selected answer choice has been processed. At step 236, the authorization manager 108 updates the messaging application 110 to include a second message indicating the selected answer choice (e.g., whether the request was denied, approved, the manner in which it was approved, etc.). At optional step 237, the messaging application 110 displays the second message (e.g., if the user loads the messaging application 110 to determine whether a response to the request has been received). At step 238, the software application manager 106, permits, based on the selected answer choice, the particular action to be performed, or prohibits the particular action from being performed. At optional step 240, the software application manager 106 provides a notification of the selected answer choice, e.g., by way of an overlay notification, a banner notification, or the like.

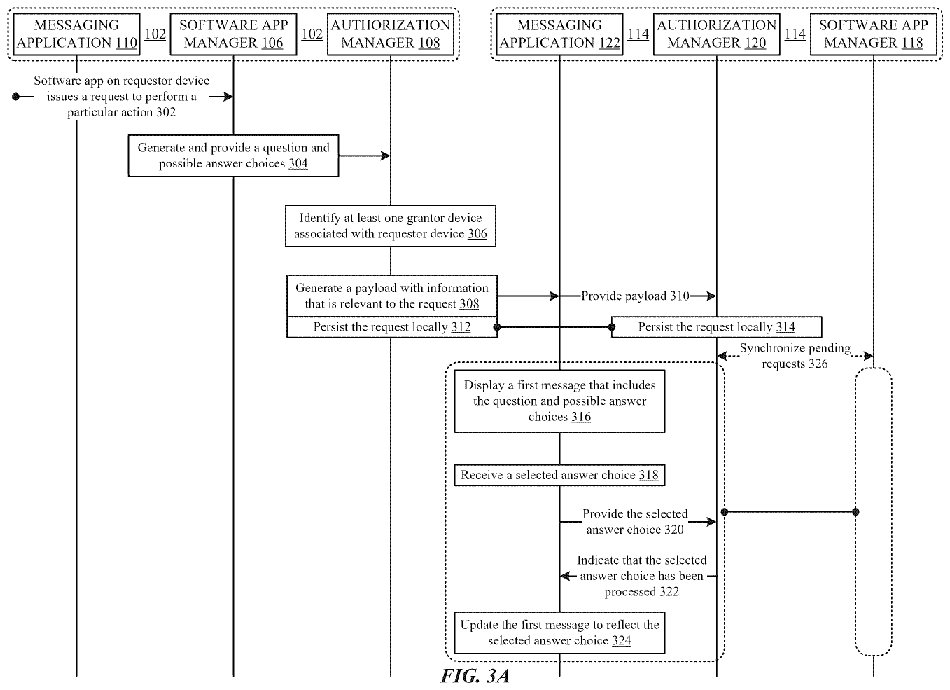

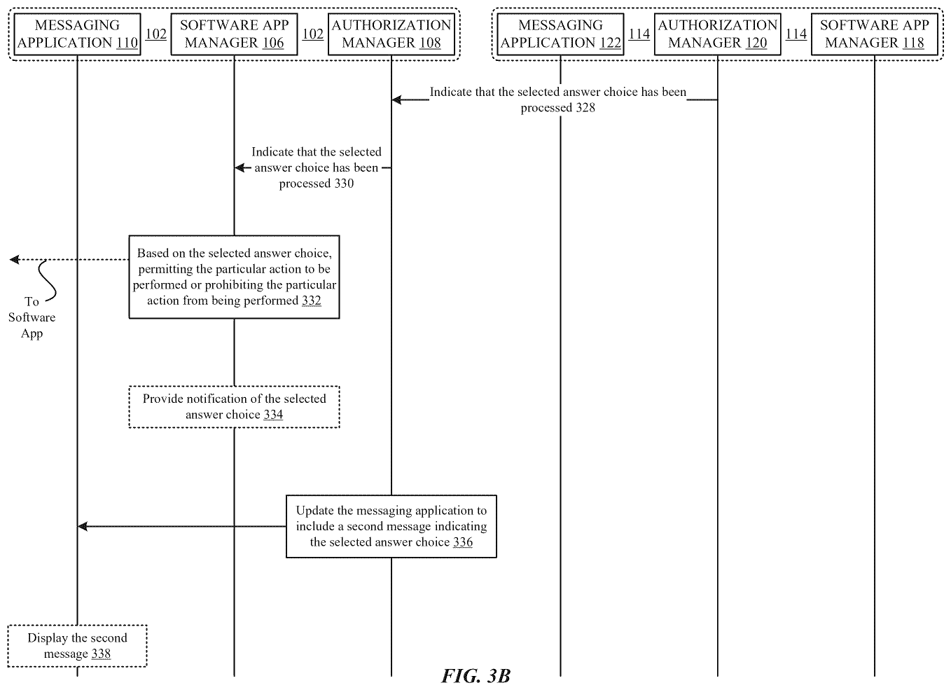

FIGS. 3A-3B illustrate sequence diagrams of a second technique for authorizing activities across computing devices, according to some embodiments. As shown in FIG. 3A, the sequence diagram begins at step 302, where a software application 104 executing on a requestor computing device 102 issues, to a software application manager 106 executing on the requestor computing device 102, a request to perform a particular action (e.g., as described above in conjunction with FIGS. 1 and 2A-2B).

At step 304, the software application manager 106 generates and provides a question and possible answer choices (e.g., as described above in conjunction with FIGS. 1 and 2A-2B). At step 306, the authorization manager 108 identifies at least one grantor computing device 114 associated with the requestor computing device 102 (e.g., as described above in conjunction with FIGS. 1 and 2A-2B). At step 308, the authorization manager 108 generates a payload with information that is relevant to the request (e.g., as described above in conjunction with FIGS. 1 and 2A-2B), and provides the payload to the grantor computing device 114 (i.e., by way of a messaging application 122 executing thereon). At step 310, the messaging application 122 provides the payload to an authorization manager 120 executing on the grantor computing device 114 (e.g., as described above in conjunction with FIGS. 1 and 2A-2B). At step 312, the authorization manager 108 persists the request locally, and, at step 314, the authorization manager 120 persists the request locally (e.g., as described above in conjunction with FIGS. 1 and 2A-2B).

At step 316, the messaging application 122 displays a first message that includes the question and possible answer choices (as well as any other useful/relevant information) (e.g., as described above in conjunction with FIGS. 1 and 2A-2B). At step 318, the messaging application 122 receives a selected answer choice (e.g., as described above in conjunction with FIGS. 1 and 2A-2B). At step 320, the messaging application 122 provides the selected answer choice to the authorization manager 120 (e.g., as described above in conjunction with FIGS. 1 and 2A-2B). At step 322, the authorization manager 120 indicates, to the messaging application 122, that the selected answer choice has been processed (e.g., as described above in conjunction with FIGS. 1 and 2A-2B). At step 324, the messaging application 122 updates the first message to reflect the selected answer choice, that the selected answer choice has been processed, etc. (e.g., as described above in conjunction with FIGS. 1 and 2A-2B).

As a brief aside, and as shown in FIG. 3A, the software application manager 118 can be configured to implement techniques that enable the question/answer choices to be viewed, as well enable an answer selection to be made, in a manner similar to that provided by the messaging application 122. In particular, and as shown in FIG. 3A, at step 326, the software application manager 118 and the authorization manager 120 can synchronize information about pending requests. For example, the software application manager 118 can issue, to the authorization manager 120, a request to view all pending requests (to perform particular actions) that are managed by the authorization manager 120. In turn, and in conjunction with receiving information about the pending requests from the authorization manager 120, the software application manager 118 can provide a user interface that enables the pending requests to be displayed. According to some embodiments, the user interface can enable, for a given pending request, the question/answer choices associated with the pending request to be viewed, a selection from among the answer choices to be made, and so on. When the selection is made—and properly processed in accordance with the techniques described herein—the pending request can be marked as completed within the user interface, can be removed from the user interface, or the like.

Turning now to FIG. 3B, at step 328, the authorization manager 120 indicates, to the authorization manager 108, that the selected answer choice has been processed (e.g., as described above in conjunction with FIGS. 1 and 2A-2B). Any communications protocol can be utilized to enable the authorization manager 120 and the authorization manager 108 to communicate information between one another, consistent with the scope of this disclosure. At step 330, the authorization manager 108 indicates, to the software application manager 106, that the selected answer choice has been processed (e.g., as described above in conjunction with FIGS. 1 and 2A-2B). At step 332, the software application manager 106, permits, based on the selected answer choice, the particular action to be performed, or prohibits the particular action from being performed (e.g., as described above in conjunction with FIGS. 1 and 2A-2B).

At optional step 334, the software application manager 106 provides a notification of the selected answer choice (e.g., as described above in conjunction with FIGS. 1 and 2A-2B). At step 336, the authorization manager 108 updates the messaging application 110 to include a second message indicating the selected answer choice (e.g., as described above in conjunction with FIGS. 1 and 2A-2B). At optional step 338, the messaging application 110 displays the second message (e.g., as described above in conjunction with FIGS. 1 and 2A-2B).

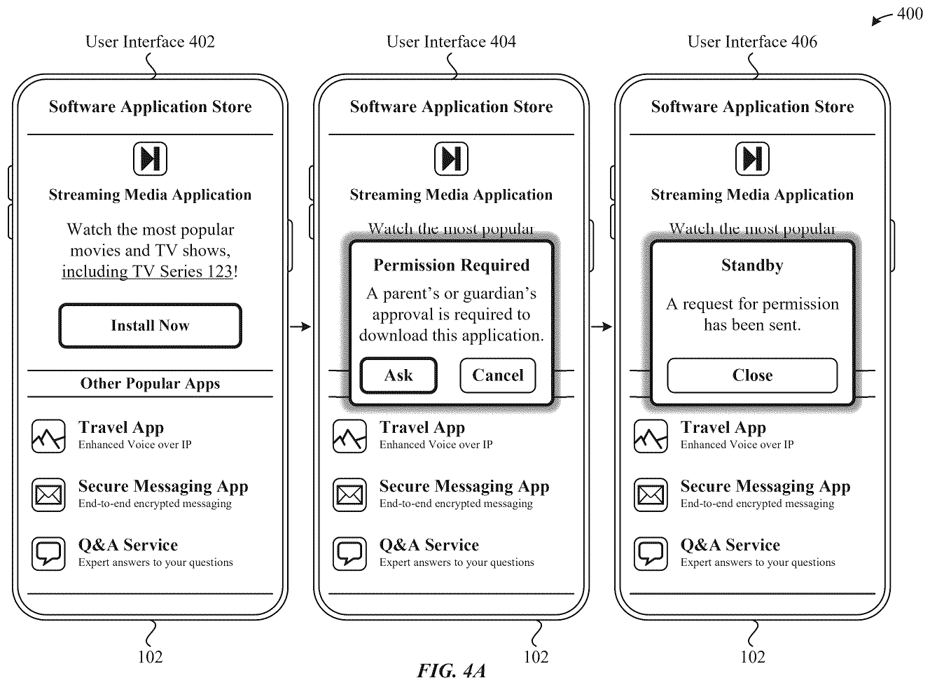

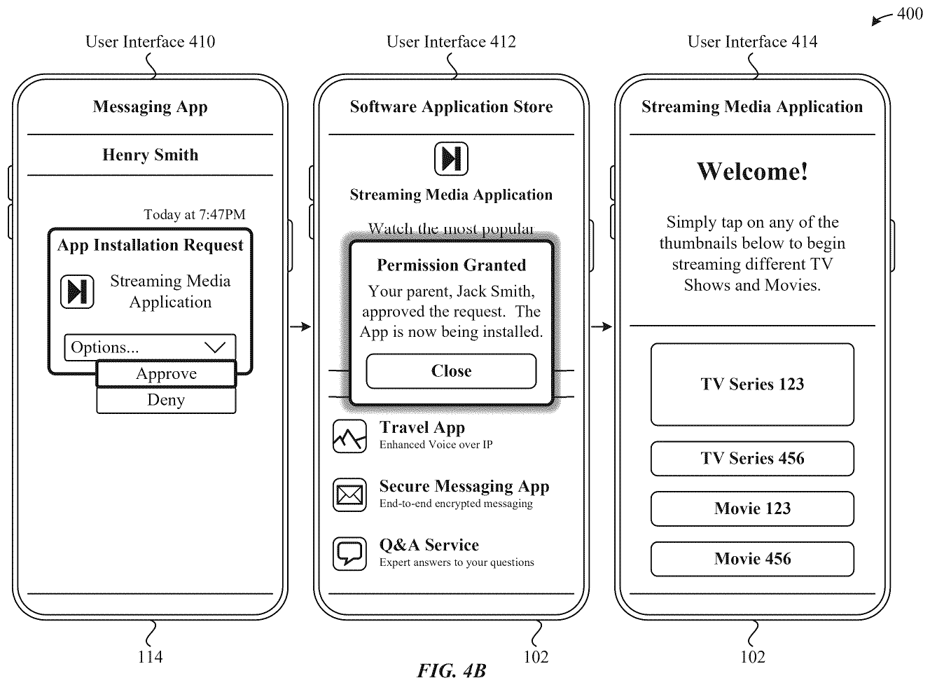

FIGS. 4A-4B illustrate conceptual diagrams 400 of user interfaces for authorizing activities across computing devices, according to some embodiments. As shown in FIG. 4A, a user interface 402 of a software application 104—a digital software application store—can be displayed on a requestor computing device 102. In the scenario illustrated in FIG. 4A, the user attempts to install a streaming media application (i.e., a new software application 104), which—under a current configuration/limitations imposed on the requestor computing device 102—constitutes a particular action that requires an approval from a grantor computing device 114.

Accordingly, and as shown in the user interface 404 of FIG. 4A, a notification can be displayed that indicates to the user of the requestor computing device 102 that the particular action requires an approval from the grantor computing device 114. As shown in FIG. 4A, the user interface 404 can enable the user to ask for authorization to perform the particular action, or can cancel the process. In the example illustrated in FIG. 4A, the user selects the option to ask for authorization to perform the particular action, and, in turn, the user interface 404 transitions to the user interface 406, which indicates that a request for the authorization has been sent.

Turning now to FIG. 4B, the grantor computing device 114 can display a user interface 410 of a messaging application 122 executing on the grantor computing device 114. As shown in FIG. 4B, the messaging application 122 can display a message in accordance with the request issued by the requestor computing device 102 to perform the particular action, which includes options to approve or deny the request. As shown in FIG. 4B, the option to approve the request is selected. In turn, the requestor computing device 102 can display a user interface 412, which indicates that permission has been granted to perform the installation. As shown in FIG. 4B, the user interface 412 can also indicate who granted the permission, as well as an update on the particular action (i.e., the installation of the streaming media application) that is being performed. In turn, the requestor computing device 102 can display a user interface 414 of the streaming media application after it has been installed.

It should be appreciated that the user interfaces illustrated in FIGS. 4A-4B are merely exemplary and not meant to be limiting. To the contrary, the user interfaces can include any amount, type, form, etc., of information, user interface elements, etc., at any level of granularity, consistent with the scope of this disclosure.

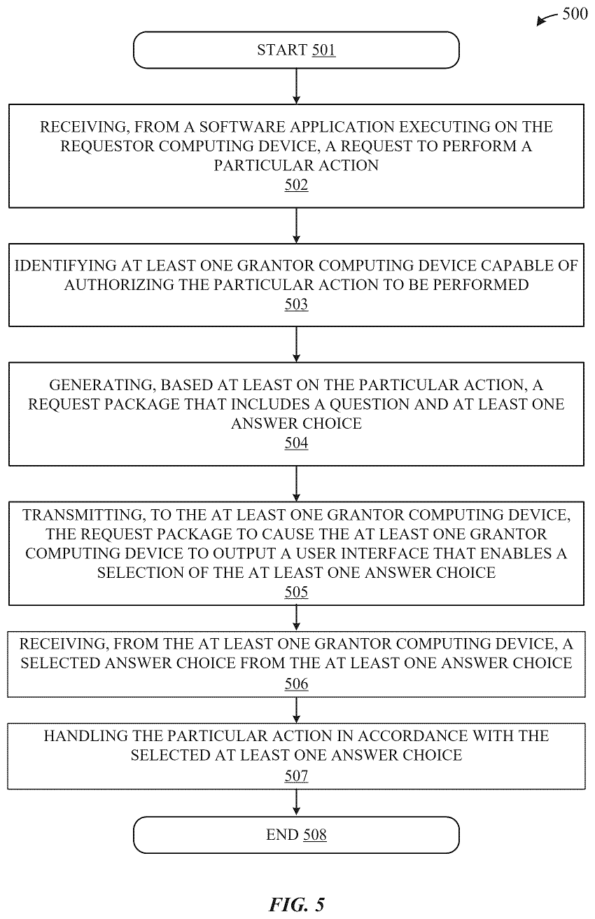

Turning to FIG. 5, a flow diagram depicting an embodiment of a method of operating a requestor computing device for authorizing activities across computing devices. The method, which may be applied to various requestor computing devices, e.g., requestor computing device 102, begins in block 501.

Method 500 includes receiving, by a requestor computing device from a software application executing on the requestor computing device, a request to perform a particular action (block 502). Method 500 also include identifying, by the requestor computing device, at least one grantor computing device capable of authorizing the particular action to be performed (block 503).

Method 500 further includes generating, by the requestor computing device and based on at least one the particular action, a request package that includes a question and at least one answer choice (block 504). Method 500 also includes transmitting, by the requestor computing device, to the at least one grantor computing device to output a user interface that enables a selection of the at least one answer choice (block 505).

In various embodiments, method 500 further includes receiving, by the requestor computing device 102, a selected answer choice from the at least one answer choice from the at least one grantor computing device (block 506). Method 500 may also include handling, by the requestor computing device, the particular action in accordance with the selected answer choice (block 507). Method 500 concludes in block 508.

Turning to FIG. 6, a flow diagram depicting an embodiment of a method operating a grantor device for authorizing activities across computing devices illustrated. Method 600, which may be applied to various grantor devices, e.g., grantor computing device 114, begins in block 601.

Method 600 includes receiving, from a requestor computing device, a request package that is based on a software application executing on the requestor computing device issuing a request to perform a particular action (block 602). In various embodiments, the request package includes a question and at least one answer choice (e.g., as described above in conjunction with FIGS. 1, 2A-2B, 3A-3B, and 4A-4B).

Method 600 further includes outputting, by the grantor computing device, a user interface that enables a selection of the at least one answer choice (block 603). In various embodiments, the at least one answer choice may be as described above in conjunction with FIGS. 1, 2A-2B, 3A-3B, and 4A-4B. Method 600 also includes receiving, by the grantor computer device, a selected answer choice from the at least one answer choice (block 604).

Method 600 further includes providing, by the grantor computing device, the selected answer choice to the requestor computing device (block 605). In various embodiments, the selected answer choice may cause the requestor computing device to handle the particular action in accordance with the selected at least one answer choice. Method 600 concludes in block 606.

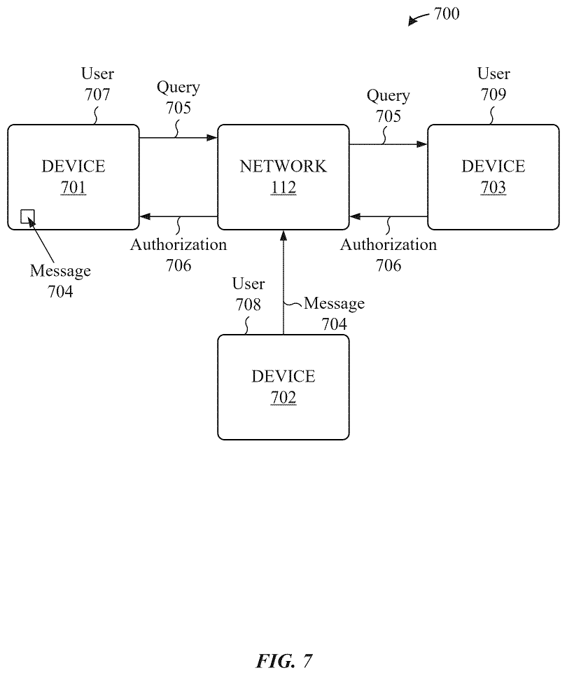

Turning to FIG. 7, a block diagram of an embodiment of a system for authorizing communication between user devices is depicted. System 700 includes devices 701-703 configured to communicate to one another via network 112. In various embodiments, device 701 may correspond to requestor computing device 102, and device 703 may correspond to grantor computing device 114. In some embodiments, device 701 is associated with user 707, device 702 is associated with user 708, and device 703 is associated with user 709.

Device 702 is configured to send message 704 to device 701 via network 112. In different embodiments, message 704 may be a text message, voice message, or any other suitable type of message. In some embodiments, user 708 may employ a messaging application executing on device 702 to generate and send message 704.

Device 701 is configured to receive message 704 from device 702 via network 112, and can be further configured to verify a communication authorization between user 707 and user 708. In some embodiments, to verify the communication authorization, device 701 may execute an authorization application, e.g., authorization manager 108 as depicted in FIG. 1. In other embodiments, to verify the communication authorization, device 701 may be further configured to check an allowed contact list for the inclusion of user 708.

In response to a determination that user 708 is not authorized to communicate with user 707, device 701 is configured to send query 705 to device 703. In various embodiments, query 705 may include a message indicating user 709 of the attempt made by user 708 to contact user 707. In some cases, query 705 may include different options that user 709 can perform. For example, query 705 may allow user 709 to block contact between user 708 and user 707, allow contact between user 708 and user 707, or initiate contact between user 709 and user 708 to allow user 709 to gain further information before making a decision regarding contact with user 707. It is noted that in cases where user 708 is permitted contact with user 707, device 701 can be configured to display message 704 for user 707.

In some cases, user 709 may be a responsible party for user 707. For example, user 707 may be a minor and user 709 may be a responsibly party, e.g., a parent, for user 707. Alternatively, user 707 may be an individual with diminished physical or mental capabilities with user 709 being their responsible party or guardian.

In response to a determination that user 709 authorizes the communication between user 708 and user 707, device 703 can be configured to send authorization 706 to device 701 via network 112. Upon receiving authorization 706, device 701 can be configured to display message 704 for user 707 to view. In some embodiments, device 701 may be additionally configured to allow user 707 to add user 708 to the allowed contacts list upon receiving authorization 706. In cases where user 709 does not want to allow communication between user 708 and user 707, no authorization is sent by device 703, and device 701 discards message 704.

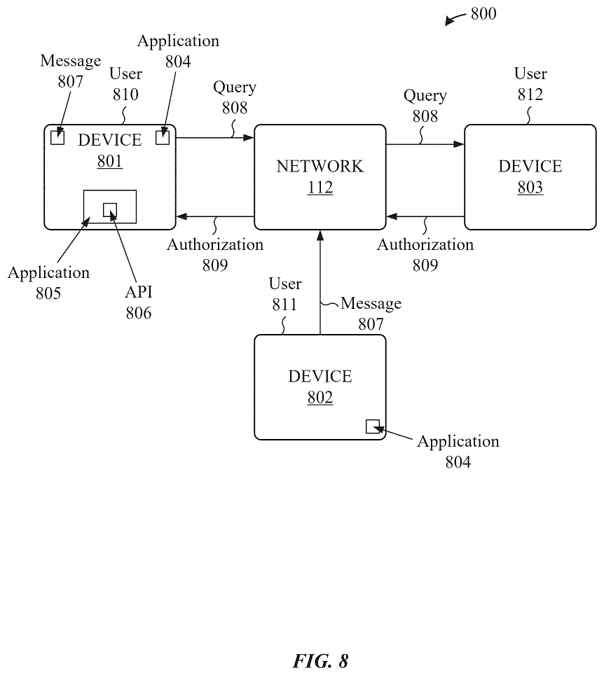

Turning to FIG. 8, a block diagram depicting an embodiment of a system for authorizing communication within an application being executed on multiple user devices is shown. As illustrated, system 800 includes devices 801-803 configured to communicate to one another via network 112. In various embodiments, device 801 may correspond to requestor computing device 102, and device 803 may correspond to grantor computing device 114. In some embodiments, device 801 is associated with user 810, device 802 is associated with user 811, and device 803 is associated with user 812.

Device 802 is configured to send message 807 to device 801 via network 112. In different embodiments, message 807 may be a text message, voice message, or any other suitable type of message. In some embodiments, user 811 may initiate message 807 through application 804. In various embodiments, application 804 may be an application that can be executed on any of devices 801-803. It is noted that application 804 may not be strictly a messaging application, but any application that allows a user to send and receive messages within application 804. For example, application 804 may be a game application, a social media application, or any other suitable application.

Device 801 is configured to receive message 807 from device 802 via network 112, and can be further configured to verify a communication authorization between user 811 and user 810. In some embodiments, to verify the communication authorization, device 801 may execute application 805, which may correspond to authorization manager 108 as depicted in FIG. 1. Application 805 may include an application programming interface (denoted as “API 806”) that is configured to allow application 804 access to functions to verify the communication authorization. In other embodiments, to verify the communication authorization, device 801 may be further configured to check an allowed contact list for the inclusion of user 811.

In response to a determination that user 811 is not authorized to communicate with user 810, device 801 is configured to send query 808 to device 803. In various embodiments, query 808 may include a message informing user 812 of the attempt made by user 811 to contact user 810. In some cases, query 808 may include different options that user 812 can perform. For example, query 808 may allow user 812 to block contact between user 811 and user 810, allow contact between user 811 and user 810, or initiate contact between user 812 and user 811 to allow user 812 to gain further information before making a decision regarding contact with user 810. It is noted that in cases where user 811 is permitted contact with user 810, device 801 can be configured to display message 807 inside of application 804 for user 810.

In some cases, user 812 may be a responsible party for user 810. For example, user 810 may be a minor and user 812 may be a responsibly party, e.g., a parent, for user 810. Alternatively, user 810 may be an individual with diminished physical or mental capabilities with user 812 being their responsible party or guardian.

In response to a determination that user 812 authorizes the communication between user 811 and user 810, device 803 can be configured to send authorization 809 to device 801 via network 112. Upon receiving authorization 809, device 801 can be configured to display message 807 for user 810 to view within application 804. In various embodiments, to display message 807, device 801 may be further configured to receive authorization 809 via API 806 of application 805, and to relay authorization 809 to application 804.

In some embodiments, device 801 may be additionally configured to allow user 810 to add user 811 to the allowed contacts list upon receiving authorization 809. In cases where user 812 does not want to allow communication between user 811 and user 810, no authorization is sent by device 803, and device 801 discards message 807.

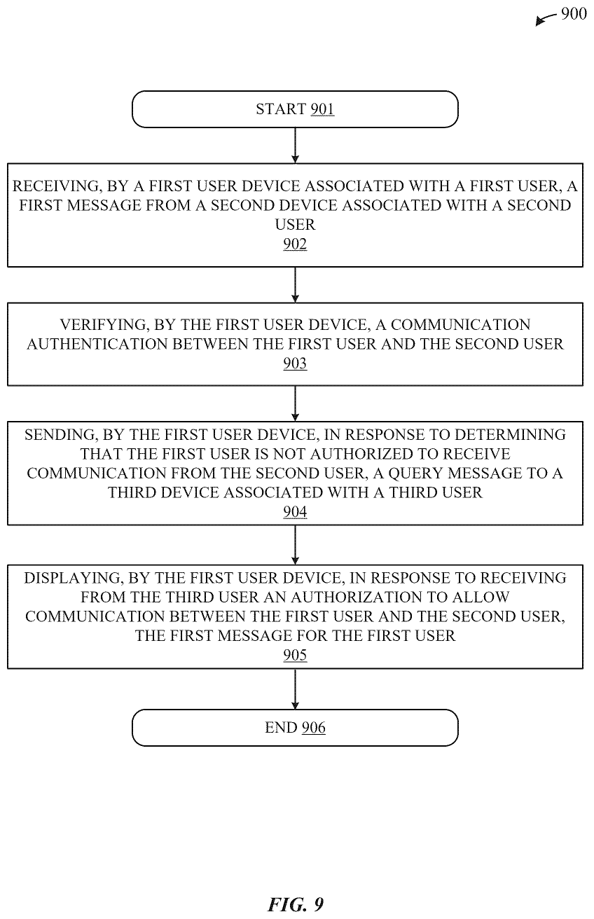

Turning to FIG. 9, a flow diagram depicting an embodiment of a method for monitoring communication between two users is depicted. Method 900, which may be applied to various systems, e.g., system 100 as depicted in FIG. 1, begins in block 901.

Method 900 includes receiving, by a first device associated with a first user, a first message from a second device associated with a second user (block 902). In various embodiments, the first user is associated with the first device. In some embodiments, the second user may send the message from a messaging application that can be executed on both the first device and the second device.

Method 900 also includes verifying, by the first device, a communication authorization between the first user and the second user (block 903). In some embodiments, verifying the communication authorization may include checking whether the second user is present on an allowed contact list associated with the first user, or any of the other methods described above.

Method 900 further includes sending, by the first device, in response to determining that the first user is not authorized to receive communication from the second user, a query message to a third device associated with a third user (block 904). In various embodiments, the query message is displayed via a messaging or other suitable application executing on the third device. In some cases, the query message may include a choice of actions the third user can perform. For example, the query message may allow the third user to block contact between the second user and the first user, allow contact between the second user and the first user, or initiate contact between the third user and the second user.

In some cases, the third user may be a responsible party for the first user. For example, the first user may be a minor and the third user may be a responsibly party, e.g., a parent, for the first user. Alternatively, the first user may be an individual with diminished physical or mental capabilities with the third user being their responsible party or guardian.

Method 900 also includes displaying, by the first device in response to receiving from the third user an authorization to allow communication between the first user and the second user, the first message for the first user (block 905). In some embodiments, method 900 may further include adding, by the first user using the first device, the second user to the allowed contact list in response to receiving the authorization. In other embodiments, method 900 may include acknowledging, by the first device to the third device, that the authorization has been received. In some cases, acknowledging that the authorization has been received may include sending a message, via a messaging or other suitable application, from the first device to the third device.

Method 900 concludes in block 906. It is noted that method 900 can be used in conjunction with any of the other methods depicted in FIGS. 5, 6, and 10.

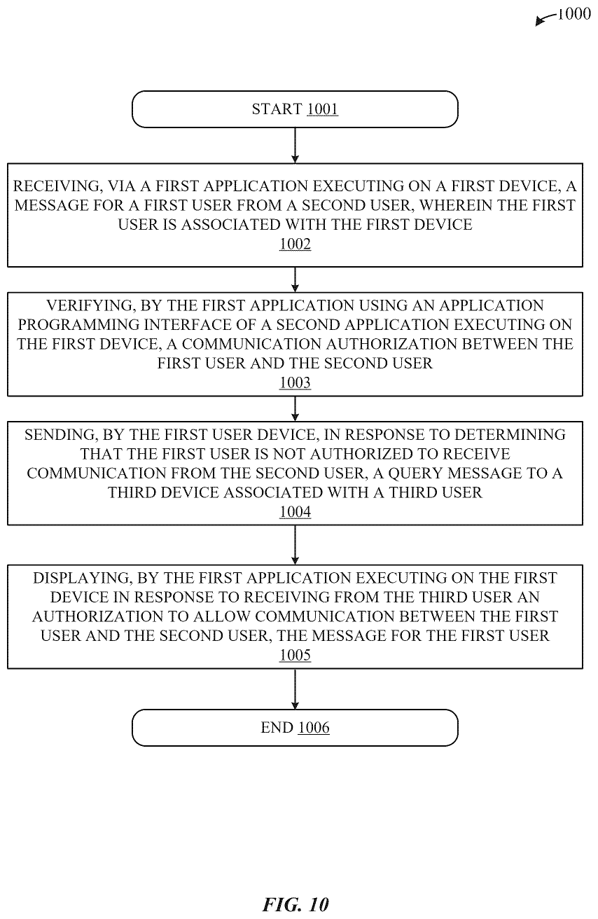

Turning to FIG. 10, a flow diagram depicting an embodiment of a method for monitoring communication received via a user through an application is depicted. Method 1000, which may be applied to various systems, e.g., system 100 as depicted in FIG. 1, begins in block 1001.

Method 1000 include receiving, via a first application executing on a first device, a message for a first user from a second user (block 1002). In various embodiments, the first user is associated with the first device. In some embodiments, the second user may send the message from a version of the first application executing on a second device associated with the second user.

Method 1000 further includes verifying, by the first application using an application programming interface of a second application executing on the first device, a communication authorization between the first user and the second user (block 1003). In some embodiments, verifying the communication authorization may include checking whether the second user is present on an allowed contact list associated with the first user, or any of the other methods described above.

Method 1000 also includes sending, by the first device in response to determining that the first user is not authorized to receive communication from the second user, a query message to a third device associated with a third user (block 1004). In various embodiments, the query message is displayed via a third application executing on the third device. In some cases, the query message may include a choice of actions the third user can perform. For example, the query message may allow the third user to block contact between the second user and the first user, allow contact between the second user and the first user, or initiate contact between the third user and the second user.

Method 1000 further includes displaying, by the first application executing on the first device, in response to receiving from the third user an authorization to allow communication between the first user and the second user, the message for the first user (block 1005). In various embodiments, displaying the message may include receiving, by the first application, the authorization via the application programming interface of the second application.

In some embodiments, method 1000 may further include adding, by the first user using the first device, the second user to the allowed contact list in response to receiving the authorization. In other embodiments, method 1000 may include acknowledging, by the first device to the third device, that the authorization has been received. In some cases, acknowledging that the authorization has been received may include sending a message via the second application from the first device to the third device.

Method 1000 concludes in block 1006. It is noted that method 1000 can be used in conjunction with any of the other methods depicted in FIGS. 5, 6, and 9.

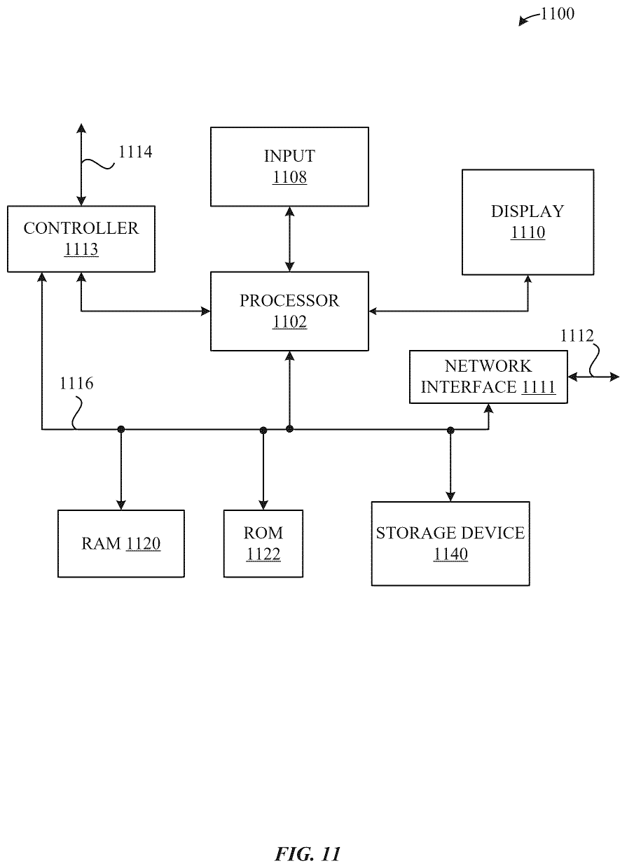

FIG. 11 illustrates a detailed view of a computing device 1100 that can be used to implement the various components described herein, according to some embodiments. In particular, the detailed view illustrates various components that can be included in the computing device described above in conjunction with FIG. 1.

As shown in FIG. 11, computing device 1100 can include a processor 1102 that represents a microprocessor or controller for controlling the overall operation of computing device 1100. The computing device 1100 can also include a user input device 1108 that allows a user of the computing device 1100 to interact with the computing device 1100. For example, the user input device 1108 can take a variety of forms, such as a button, keypad, dial, touch screen, audio input interface, visual/image capture input interface, input in the form of sensor data, etc. Furthermore, the computing device 1100 can include a display 1110 (screen display) that can be controlled by the processor 1102 to display information to the user. A data bus 1116 can facilitate data transfer between at least a storage device 1140, the processor 1102, and a controller 1113. The controller 1113 can be used to interface with and control different equipment through an equipment control bus 1114. The computing device 1100 can also include a network/bus interface 1111 that couples to a data link 1112. In the case of a wireless connection, the network/bus interface 1111 can include a wireless transceiver.

The computing device 1100 also includes a storage device 1140, which can include a single disk or a plurality of disks (e.g., SSDs), and includes a storage management module that manages one or more partitions within the storage device 1140. In some embodiments, storage device 1140 can include flash memory, semiconductor (solid state) memory or the like. The computing device 1100 can also include a Random-Access Memory (RAM) 1120 and a Read-Only Memory (ROM) 1122. The ROM 1122 can store programs, utilities, or processes to be executed in a non-volatile manner. The RAM 1120 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information, and the like), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
receiving, from a software application executing on a requestor computing device, a request to perform a particular action;
identifying at least one grantor computing device capable of authorizing the particular action to be performed;
generating, based at least on the particular action, a request package that includes a question and at least one answer choice;
transmitting, to the at least one grantor computing device, the request package to cause the at least one grantor computing device to output a user interface that enables a selection of the at least one answer choice;
receiving, from the at least one grantor computing device, a selected answer choice from the at least one answer choice; and
handling the particular action in accordance with the selected answer choice.

2. The method of claim 1, wherein:
the request package is transmitted by way of a messaging protocol that is accessible to the requestor computing device; and
the at least one grantor computing device executes a messaging application that:
implements the messaging protocol,
receives the request package by way of the messaging protocol, and
is associated with the user interface, wherein the user interface conveys the question and the at least one answer choice.

3. The method of claim 2, wherein:
the request package further includes additional information comprising a name associated with a user associated with the requestor computing device, an identifier associated with the requestor computing device, identifying information associated with the software application, or some combination thereof; and
the user interface further conveys at least some of the additional information.

4. The method of claim 2, wherein the selected answer choice is received by way of the messaging protocol.

5. The method of claim 1, wherein handling the particular action in accordance with the at least one answer choice comprises:
permitting the particular action to be performed based on the at least one answer choice; or
prohibiting the particular action from being performed.

6. The method of claim 1, further comprising, prior to identifying the at least one grantor computing device:
causing the requestor computing device to output a second user interface that:
indicates an authorization is needed to perform the particular action,
provides a first option to issue the request package for the authorization, and
provides a second option to forego issuing the request package for the authorization.

7. The method of claim 1, wherein:
the requestor computing device is associated with a child user account that belongs to a family group; and
the at least one grantor computing device is associated with a parent or a guardian user account that belongs to the family group and that is permitted to authorize actions requested to be performed by child user accounts that are members of the family group.

8. A non-transitory computer readable storage medium configured to store instructions that, when executed by at least one processor included in a requestor computing device, cause the requestor computing device to carry out steps that include:
receiving, from a software application executing on the requestor computing device, a request to perform a particular action;
identifying at least one grantor computing device capable of authorizing the particular action to be performed;
generating, based at least on the particular action, a request package that includes a question and at least one answer choice;
transmitting, to the at least one grantor computing device, the request package to cause the at least one grantor computing device to output a user interface that enables a selection of the at least one answer choice;
receiving, from the at least one grantor computing device, a selected answer choice from the at least one answer choice; and
handling the particular action in accordance with the selected answer choice.

9. The non-transitory computer readable storage medium of claim 8, wherein:
the request package is transmitted by way of a messaging protocol that is accessible to the requestor computing device; and
the at least one grantor computing device executes a messaging application that:
implements the messaging protocol,
receives the request package by way of the messaging protocol, and
is associated with the user interface, wherein the user interface conveys the question and the at least one answer choice.

10. The non-transitory computer readable storage medium of claim 9, wherein:
the request package further includes additional information comprising a name associated with a user associated with the requestor computing device, an identifier associated with the requestor computing device, identifying information associated with the software application, or some combination thereof; and
the user interface further conveys at least some of the additional information.

11. The non-transitory computer readable storage medium of claim 9, wherein the selected answer choice is received by way of the messaging protocol.

12. The non-transitory computer readable storage medium of claim 8, wherein handling the particular action in accordance with the at least one answer choice comprises:
permitting the particular action to be performed based on the at least one answer choice; or
prohibiting the particular action from being performed.

13. The non-transitory computer readable storage medium of claim 8, wherein the steps further include, prior to identifying the at least one grantor computing device:
causing the requestor computing device to output a second user interface that:
indicates an authorization is needed to perform the particular action,
provides a first option to issue the request package for the authorization, and
provides a second option to forego issuing the request package for the authorization.

14. The non-transitory computer readable storage medium of claim 8, wherein:
the requestor computing device is associated with a child user account that belongs to a family group; and
the at least one grantor computing device is associated with a parent or a guardian user account that belongs to the family group and that is permitted to authorize actions requested to be performed by child user accounts that are members of the family group.

15. A requestor computing device, comprising:
at least one processor; and
at least one memory storing instructions that, when executed by the at least one processor, cause the requestor computing device to carry out steps that include:
receiving, from a software application executing on the requestor computing device, a request to perform a particular action;
identifying at least one grantor computing device capable of authorizing the particular action to be performed;
generating, based at least on the particular action, a request package that includes a question and at least one answer choice;
transmitting, to the at least one grantor computing device, the request package to cause the at least one grantor computing device to output a user interface that enables a selection of the at least one answer choice;
receiving, from the at least one grantor computing device, a selected answer choice from the at least one answer choice; and
handling the particular action in accordance with the selected answer choice.

16. The requestor computing device of claim 15, wherein:
the request package is transmitted by way of a messaging protocol that is accessible to the requestor computing device; and
the at least one grantor computing device executes a messaging application that:
implements the messaging protocol,
receives the request package by way of the messaging protocol, and
is associated with the user interface, wherein the user interface conveys the question and the at least one answer choice.

17. The requestor computing device of claim 16, wherein:
the request package further includes additional information comprising a name associated with a user associated with the requestor computing device, an identifier associated with the requestor computing device, identifying information associated with the software application, or some combination thereof; and
the user interface further conveys at least some of the additional information.

18. The requestor computing device of claim 16, wherein the selected answer choice is received by way of the messaging protocol.

19. The requestor computing device of claim 15, wherein handling the particular action in accordance with the at least one answer choice comprises:
permitting the particular action to be performed based on the at least one answer choice; or
prohibiting the particular action from being performed.

20. The requestor computing device of claim 15, wherein the steps further include, prior to identifying the at least one grantor computing device:
causing the requestor computing device to output a second user interface that:
indicates an authorization is needed to perform the particular action,
provides a first option to issue the request package for the authorization, and
provides a second option to forego issuing the request package for the authorization.
